(19) United States
(12) Patent Application Publication
(10) Pub. No.: US 2024/0158945 A1
(43) Pub. Date: May 16, 2024

(54) COLOR-CHANGING ELECTROPHORETIC THREADS AND FIBERS, AND METHODS AND APPARATUSES FOR MAKING THE SAME

(71) Applicant: E INK CORPORATION, Billerica, MA (US)

(72) Inventors: Nishit MURARI, Westford, MA (US); Jay William ANSETH, Canton, MA (US); Richard J. PAOLINI, JR., Framingham, MA (US)

(21) Appl. No.: 18/389,335

(22) Filed: Nov. 14, 2023

Related U.S. Application Data
(60) Provisional application No. 63/383,796, filed on Nov. 15, 2022.

(51) Int. Cl. C25D 13/04; C25D 13/16

(52) U.S. Cl. CPC C25D 13/04; C25D 13/16

(57) ABSTRACT

A method and apparatus for fabricating a color-changing thread is described. The method includes providing an aqueous slurry including an encapsulated electrophoretic medium and a binder. The electrophoretic medium includes a first and a second type of electrophoretic particles. The first type of electrophoretic particles have a different charge and color than the second type of electrophoretic particles. The method also includes injecting the aqueous slurry into a fluid reservoir holding an aqueous cross-linker, and forming a hydrogel matrix that entraps the encapsulated electrophoretic medium within a cross-linked binder. The apparatus includes a body housing multiple reservoirs for holding materials used to form color-changing microcapsule threads. Solutions of materials are dispensed simultaneously with a cross-linking agent through a multi-chamber needle form the threads by an ionic cross-linking reaction.

### CROSS-REFERENCE TO RELATED APPLICATIONS

This application claims priority to U.S. Provisional Application 63/383,796, filed on Nov. 15, 2022, the entire contents of which are incorporated herein by reference. Further, the entire contents of any patent, published application, or other published work referenced herein are incorporated by reference in their entireties.

### FIELD OF THE INVENTION

This invention relates to color-changing threads and fibers. More specifically, this invention relates to spoolable polymeric threads with tunable mechanical and electrical properties that contain microcapsules and self-contained electrophoretic print heads and pens for fabricating the same.

### BACKGROUND OF THE INVENTION

There are many applications for clothing that can change on demand. If modern fabrics were able to change color on demand, a consumer could dramatically reduce the number of articles of clothing that he or she purchased in a lifetime. It would no longer be necessary to have, for example, three different blouses of nearly identical cut but different color. The consumer could simply chose the color (or pattern) needed depending upon the event, season, etc. In this way, color changing fabrics could greatly reduce the environmental impact of clothing. Additionally, replacing these clothes with each new fashion season is resource-intensive—regardless of the source of the fabric, e.g., cotton, wool, or petrochemicals. Other applications for color changing clothing include camouflage and sportswear. For example, a baseball team would no longer require two different uniforms, the color could be changed depending upon whether the team was home or away.

A variety of technologies have been identified for creating fabrics that are able to reversibly change colors. These technologies include thermochromic dyes, which change color when exposed to different temperatures, photochromic dyes, which change color when exposed to sunlight, integrated LEDs, which can be illuminated on demand by providing power to the diodes, and liquid crystal inks, which allow different colors to be shown (or not) with the presence of a supplied electric field. These technologies have been highlighted in various prototypes, but only the thermochromic dyes have been widely incorporated into clothing. See “Hypercolor” t-shirts sold by Generra Sportswear. However, because the thermochromic clothing is heat sensitive, the color patterns are variable. For example, the underarms of a t-shirt having thermochromic ink may be consistently a different shade, drawing attention to that area.

One proposed solution includes fabricating electrophoretic filaments, threads or strings utilizing a thin, flexible, transparent tube electrode filled with ink. A wire electrode is drawn through the tube (without contacting the walls), and the ends of the tube are sealed, thereby completing the device. In one alternate solution, a transparent tube is filled with the ink and a thin wire electrode is drawn through the tube. The tube is crimped thermally or chemically to create a series of capsules each containing the dispersion of ink and a length of electrode. A transparent electrode is then applied to the exterior of the crimped tube, forming the thread. Applying a voltage between electrodes causes the thread to change color.

Other possible solutions relate to the formation of a non-electrophoretic microcapsule thread by attaching microcapsules to the thread. For example, the non-electrophoretic microcapsule threads can be made via dip coating, where threads are dipped in a slurry containing the microcapsules and pulled out slowly to get a decent covering. Slurry viscosity, drawing speed, and thread core diameter determine the processed thread's final thickness. Electrodeposition has also been used by biasing a conductive core with high voltage to cause a material containing non-electrophoretic microcapsules to adhere to the core.

However, such solutions typically involve complex fabrication processes with limited or restricted applications for the finished product. For example, presence of the tube or thread limits the flexibility and thickness of the microcapsule wire. Also, spooling the finished thread is problematic, if not impossible, if the capsule core contains a wire. Otherwise, a complex process is required to maintain very precise control over the tension on the thread. Further, variations in environmental factors can lead to delamination of the capsules from the thread due to differences in each material's coefficient of thermal expansion. Changes in processing parameters or surface energy during the coating process can also lead to uncoated areas. Finally, there are safety concerns associated with the application of high voltage to the wire core during electrodeposition.

Another proposed solution is forming a hollow fiber that is subsequently filled with an electro-optic medium, such as an electrophoretic medium, as is disclosed in U.S. Pat. No. 10,962,816. The fiber may be prepared by using a syringe, for example, to fill an extruded hollow fiber that has conductive wire electrodes imbedded lengthwise with a liquid electro-optic medium comprising electrophoretically active pigment particles dispersed in a non-polar solvent. However, some of the disadvantages associated with this proposed fiber include undesired pigment settling, difficulties in filling appreciable lengths of fiber whose hollow cavity dimension is less than 200 microns, and inability to cut the fiber to different lengths without compromising the function of the entire fiber as a result of dispersion leaking out of the hollow fiber's internal cavity.

### SUMMARY OF THE INVENTION

From the foregoing, it can be appreciated that there remains a need for robust yet flexible threads that can change color on demand. There is also a need for color-changing threads that can be produced using simplified manufacturing processes.

The invention described herein overcomes the shortcomings of the prior art by providing flexible threads or fibers that can be switched between colors on demand, and are more mechanically robust. The invention also provides a method of fabricating spoolable microcapsule threads having a controlled length and thickness. The methods used for fabrication are safe and environmentally green. Because the inventive microcapsule fiber does not require a tube or thread at its core, it is possible to fabricate a free standing electrophoretic fiber with high flexibility and strength. If required, a central core can easily be inserted or fabricated using a variety of materials such as wires, polymers, or nanoparticles.

The fibers may be incorporated into fabrics by weaving, knitting, embroidering, thermoforming, or matting. The fibers can be incorporated into other materials to achieve strength, breathability, or stretch as demanded by the application. When a suitable electric field is provided between the electrodes of the fiber, the color of the fiber will switch. Because the pigments are bistable, it is not necessary to provide constant power to maintain the color state. Rather, once the fabric is switched, it is stable for long periods of time, e.g., days or weeks.

The invention also describes improved processes for fabricating microcapsule threads, including self-contained pen dispensers and print heads. Conventional technology includes ink jet pens and multi-chamber cartridges for storing and dispensing ink of different colors on a “drop on demand” basis. Such print heads are designed to deliver different inks at a controlled rate and time in order to mix the right combinations of inks to achieve the desired color. However, conventional print head technology is not able to deliver active ingredients which undergo reactions to form or deliver a new material having vastly different properties to its constituent parts. Microfluidics applications have used multi-chambered micromixers to precisely combine and mix minute volumes of ingredients for producing, for example, pharmaceuticals. However, microfluidics technology is unsuitable for producing color-changing fibers that are flexible yet mechanically robust enough to be incorporated into other materials.

The creation of fibers containing bistable electronic ink and the subsequent incorporation of the fibers into fabrics, apparel, etc., would enable switching of the fabrics and then disconnecting them from electronics because the display is stable with no power. Accordingly, the drive electronics would not have to be integrated into the fabric unless mobile switching was desired. Thus, in some embodiments, a switching box, which could be battery powered, is a detachable accessory. The lack of driving electronics greatly simplifies laundering the fibers while also increasing durability. If it is desirable to have the device changing actively while worn, the switching electronics could be included in the garment but would only have to be turned on for brief periods during the updates.

These and other aspects of the present invention will be apparent in view of the following description.

In one aspect, the invention features a method for fabricating a color-changing thread. The method includes providing an aqueous slurry comprising an encapsulated electrophoretic medium and a binder. The electrophoretic medium includes a first and a second type of electrophoretic particles. The first type of electrophoretic particles has a different charge and color than the second type of electrophoretic particles. The method also includes injecting the aqueous slurry into a fluid reservoir holding an aqueous cross-linker, and forming a hydrogel matrix that entraps the encapsulated electrophoretic medium within a cross-linked binder.

In another aspect, the invention features a method for fabricating a color-changing thread. The method includes providing an aqueous slurry comprising an encapsulated electrophoretic medium and a binder. The electrophoretic medium includes a first and a second type of electrophoretic particles. The first type of electrophoretic particles has a different charge and color than the second type of electrophoretic particles. The method also includes dispensing the aqueous slurry from a first outlet of a dispenser, and dispensing an aqueous cross-linker from a second outlet of the dispenser proximate to the first outlet, thereby forming a hydrogel matrix that entraps the encapsulated electrophoretic medium within a cross-linked binder.

Aspects of the invention can include one or more of the following features. In some embodiments, the aqueous binder comprises a polysaccharide. In some embodiments, the aqueous binder comprises sodium alginate. In some embodiments, the aqueous cross-linker comprises calcium chloride.

In some embodiments, the aqueous binder further comprises a plasticizer. In some embodiments, the plasticizer comprises one of glycerin and xylitol. In some embodiments, the hydrogel matrix comprises calcium alginate. In some embodiments, the electrophoretic medium is bistable. In some embodiments, the electrophoretic medium comprises a non-polar solvent, polymer stabilizers, and charge control agents.

In some embodiments, the first outlet is laterally adjacent to the second outlet. In some embodiments, the dispenser comprises a coaxial needle. In some embodiments, the first outlet radially surrounds the second outlet.

In some embodiments, the method also includes providing a conductive core, and coating at least a portion of the conductive core with the hydrogel matrix. In some embodiments, coating includes dipping the conductive core in the hydrogel matrix, and drawing the conductive core from the hydrogel matrix at a predetermined rate, thereby forming a hydrogel-matrix-coated conductive core. In some embodiments, the conductive core material comprises one of conductive carbon, nanoparticles, metal wire, and a polymer.

In some embodiments, the method further includes dipping the hydrogel-matrix-coated conductive core in a conductive polymer, and drawing the hydrogel-matrix-coated conductive core from the conductive polymer at a second predetermined rate, thereby coating the hydrogel-matrix-coated conductive core with a conductive electrode layer. In some embodiments, the conductive polymer material comprises one of PEDOT, polyacetylene, polyphenylene sulfide, and polyphenylene vinylene.

In some embodiments, the second outlet radially surrounds a third outlet of the dispenser.

In some embodiments, the method further includes extruding a conductive core material from the third outlet simultaneously with the slurry and the aqueous cross-linker. The hydrogel encapsulates the electrophoretic medium surrounds the conductive core material.

In some embodiments, the conductive core material comprises one of conductive carbon, nanoparticles, metal wire, and a polymer. In some embodiments, a fourth outlet of the dispenser radially surrounds the first outlet.

In some embodiments, the method further includes extruding a conductive polymer material from the fourth outlet simultaneously with the slurry, the aqueous cross-linker, and the conductive core, thereby forming a conductive electrode layer surrounding the hydrogel and the conductive core material. In some embodiments, the conductive polymer material comprises one of PEDOT, polyacetylene, polyphenylene sulfide, and polyphenylene vinylene.

In some embodiments, the dispenser is capable of motion about one or more axes.

### BRIEF DESCRIPTION OF DRAWINGS

Additional details of one or more embodiments of the subject matter described in this specification are set forth in the accompanying drawings and the description below. Other features, aspects, and advantages of the subject matter will become apparent from the descriptions contained herein and the accompanying drawings. The drawings are not necessarily to scale and elements of similar structures are generally annotated with like reference numerals for illustrative purposes throughout the drawings. However, the specific properties and functions of elements in different embodiments may not be identical. Further, the drawings are only intended to facilitate the description of the subject matter. The drawings do not illustrate every aspect of the described embodiments and do not limit the scope of the present disclosure or claims.

FIG. 1 is a diagram illustrating microcapsules in a hydrogel polymer matrix of polysaccharide in accordance with the subject matter presented herein.

FIG. 2A is a diagram illustrating a method of fabricating microcapsule threads by dispensing a polysaccharide microcapsule solution in a cross-linker bath.

FIG. 2B is a diagram illustrating a method of fabricating microcapsule threads using a coaxial needle for simultaneous dispersion of a polysaccharide microcapsule solution and cross-linker.

FIG. 3A is schematic diagram showing the exemplary structure of a microcapsule thread in accordance with the subject matter presented herein.

FIG. 3B shows an optical image of a microcapsule thread in accordance with the subject matter presented herein.

FIG. 4A shows an optical image of a microcapsule thread fabricated with a predefined thickness and length in accordance with the subject matter presented herein.

FIG. 4B shows an optical image of a microcapsule thread being wound around a spool in accordance with the subject matter presented herein.

FIG. 4C shows an optical image of a coaxial microcapsule thread that has been fabricated around a core in accordance with the subject matter presented herein.

FIG. 5 shows a cross-sectional diagram of an exemplary microcapsule thread dispenser in accordance with the subject matter disclosed herein.

FIG. 6 is a detail view of flow valves within the dispenser in accordance with the subject matter disclosed herein.

FIG. 7 shows a cross-sectional diagram of an exemplary color changing electrophoretic thread formed by the inventive dispenser disclosed herein.

FIG. 8A shows an optical image of an exemplary conductive thread made from silver coated PMMA beads in an alginate hydrogel in accordance with the subject matter disclosed herein.

FIG. 8B shows an optical image of an exemplary conductive thread made from gold particles via cross-linking of sodium alginate with calcium chloride in accordance with the subject matter disclosed herein.

FIG. 8C shows an optical image of non-conductive threads 815 and conductive carbon threads drawn onto glass slides in accordance with the subject matter disclosed herein.

FIG. 8D shows an optical image of a microcapsule thread having microcapsules trapped within in a hydrogel polymer matrix in accordance with the subject matter disclosed herein.

FIG. 8E is a schematic diagram showing an exemplary test setup used to test the electrophoretic activity of a microcapsule thread in accordance with the subject matter disclosed herein.

FIG. 8F shows an optical image of a microcapsule thread that has been driven to a black or dark state in accordance with the subject matter disclosed herein.

FIG. 8G shows an optical image of a microcapsule thread that has been driven to a light or white state in accordance with the subject matter disclosed herein.

FIG. 9 shows a schematic diagram of a print head including a multi-reservoir assembly for storing materials used in the synthesis of color changing electrophoretic threads.

FIG. 10 is an optical image of an exemplary biaxial needle in accordance with the subject matter disclosed herein.

FIG. 11 is an optical image of an exemplary pentaxial needle in accordance with the subject matter disclosed herein.

FIG. 12A shows a schematic diagram of a pin and connector configuration termed the “pi connector” for making connections to a color-changing electrophoretic thread in accordance with the subject matter disclosed herein.

FIG. 12B shows a schematic diagram of a linear connector configuration for making connections to a color-changing electrophoretic thread such as thread in accordance with the subject matter disclosed herein.

FIG. 12C shows a schematic diagram of a coaxial connector configuration for making connections to a color-changing electrophoretic thread in accordance with the subject matter disclosed herein.

FIG. 13 shows a schematic diagram of a microcapsule thread incorporating a transparent conductor on its top side and a highly conductive line on its bottom side in accordance with the subject matter disclosed herein.

FIG. 14 shows a schematic diagram of a microcapsule thread incorporating small diameter wires within the outer transparent conductor in accordance with the subject matter disclosed herein.

### DETAILED DESCRIPTION OF THE INVENTION

In the following detailed description, numerous specific details are set forth by way of examples in order to provide a thorough understanding of the relevant teachings. However, it should be apparent to those skilled in the art that the present teachings may be practiced without such details.

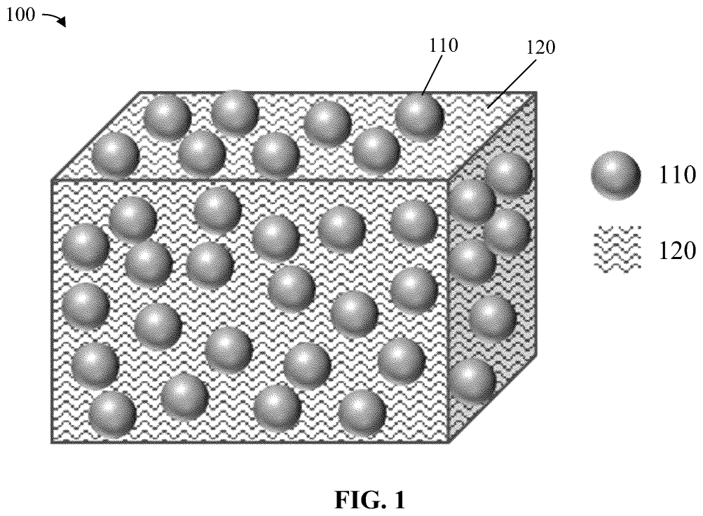

The invention provides spoolable polymeric functional threads with tunable properties. The threads can be fabricated by entrapping active microcapsules in a hydrogel matrix via triggered cross-linking of polysaccharides by ion exchange. For example, when a mixture of electrophoretic microcapsules and a polysaccharide solution is passed through a cross-linker, rapid gelation traps the microcapsules in a hydrogel matrix. FIG. 1 is a diagram 100 illustrating electrophoretic microcapsules 110 trapped within in a hydrogel polymer matrix 120 of polysaccharide.

Microcapsules 110 can comprise solid electro-optic material. Some electro-optic materials are solid in the sense that the materials have solid external surfaces, although the materials may, and often do, have internal liquid- or gas-filled spaces. Thus, the term “solid electro-optic material” may include rotating bichromal members, encapsulated electrophoretic media, and encapsulated liquid crystal media.

Electro-optic media of a rotating bichromal member type are described, for example, in U.S. Pat. Nos. 5,808,783; 5,777,782; 5,760,761; 6,054,071 6,055,091; 6,097,531; 6,128,124; 6,137,467; and 6,147,791 (although this type of media is often referred to as a “rotating bichromal ball,” the term “rotating bichromal member” is preferred as more accurate since in some of the patents mentioned above the rotating members are not spherical). Such media uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the material is changed by applying an electric field thereto, thus rotating the bodies to various positions and varying which of the sections of the bodies is seen through a viewing surface. This type of electro-optic medium is typically bistable.

The terms “bistable” and “bistability” are used herein in their conventional meaning in the art to refer to electro-optic materials having first and second states differing in at least one optical property, and such that after the electro-optic material has been driven, by means of an addressing pulse of finite duration, to assume either its first or second state, after the addressing pulse has terminated, that state will persist for at least several times, for example at least four times, the minimum duration of the addressing pulse required to change the state of the electro-optic material. It is shown in U.S. Pat. No. 7,170,670 that some particle-based electrophoretic materials capable of gray scale are stable not only in their extreme black and white states but also in their intermediate gray states, and the same is true of some other types of electro-optic media. This type of media is properly called “multi-stable” rather than bistable, although for convenience the term “bistable” may be used herein to cover both bistable and multi-stable media.

The term “gray state” is used herein in its conventional meaning in the imaging art to refer to a state intermediate two extreme optical states, and does not necessarily imply a black-white transition between these two extreme states. For example, several of the E Ink patents and published applications referred to below describe electrophoretic material in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a material, and should be understood as normally including extreme optical states which are not strictly black and white, for example the aforementioned white and dark blue states. The term “monochrome” may be used hereinafter to denote a drive scheme which only drives electro-optic media to their two extreme optical states with no intervening gray states.

Another type of electro-optic media uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic media may be found in electro-wetting displays developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting media can be made bistable.

One type of electro-optic media, which has been the subject of intense research and development for a number of years, is the particle-based electrophoretic media, in which a plurality of charged particles move through a fluid under the influence of an electric field. Electrophoretic media can have attributes of good brightness and contrast, wide viewing angles, state bistability, and low power consumption when compared with liquid crystal displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291.

Numerous patents and applications assigned to or in the names of the Massachusetts Institute of Technology (MIT), E Ink Corporation, E Ink California, LLC and related companies describe various technologies used in encapsulated electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Films and sub-assemblies containing electro-optic materials; see for example U.S. Pat. Nos. 6,982,178 and 7,839,564;
(d) Backplanes, adhesive layers and other auxiliary layers and methods used in displays; see for example U.S. Pat. Nos. 7,116,318 and 7,535,624;
(e) Color formation and color adjustment; see for example U.S. Pat. Nos. 7,075,502 and 7,839,564;
(f) Methods for driving displays; see for example U.S. Pat. Nos. 7,012,600 and 7,453,445; and
(g) Applications of displays; see for example U.S. Pat. Nos. 7,312,784 and 8,009,348.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

Encapsulated electrophoretic media typically does not suffer from clustering and settling failure and provides further advantages, such as the ability to print or coat the media on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Further, because the medium can be printed (using a variety of methods), an application utilizing the medium can be made inexpensively.

Returning to FIG. 1, the hydrogel polymer matrix 120 can be a hydrogel formed using a cross-linking procedure. In some embodiments, the hydrogel polymer matrix 120 is calcium alginate. The hydrogel polymer matrix 120 provides the necessary strength and flexibility to hold the microcapsules 110 together to form a continuous free-standing spoolable thread.

In order to fabricate a free-standing spoolable thread, slurries of microcapsules 110 in a polysaccharide solution can be dispensed into a bath of a cross-linker. Alternatively, a biaxial or coaxial needle can be used to dispense the polysaccharide solution and cross-linker simultaneously (resulting in gelation upon exit from the needle). Mechanical and electrical properties of the resulting thread can be tuned by changing the amount of binder and/or plasticizers relative to the amount of microcapsules. The diameter of the thread can be changed by adjusting the gauge of the dispensing needle or by providing a pulling force.

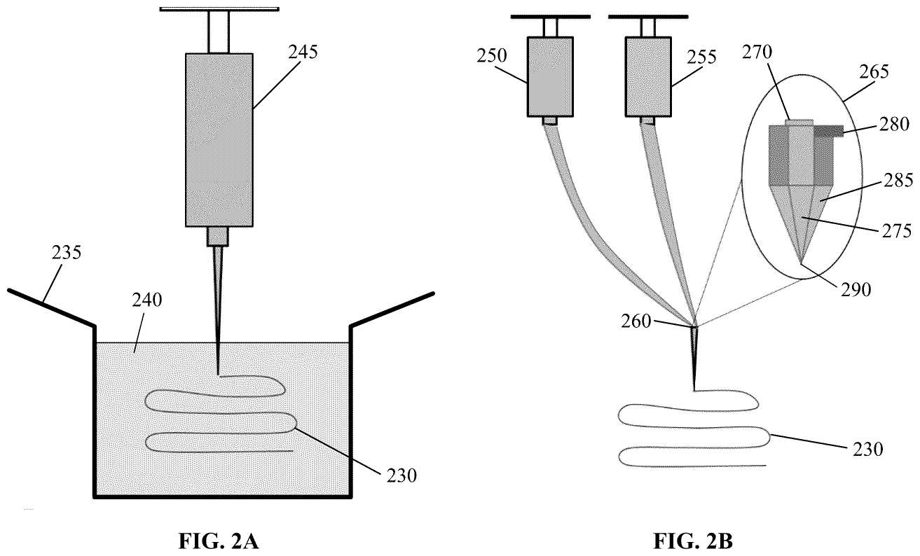

An exemplary fabrication process will now be described in connection with FIG. 2A and FIG. 2B. A spoolable electrophoretic capsule thread can be formed using sodium alginate as a binder, and calcium chloride as a cross-linker. To enhance flexibility, a polyurethane, preferably a polyurethane doped with conductive materials such as conductive monomers, salts, or free acids/bases, can also be used.

A mixing process is used to form the binder. For example, polysaccharides, such as sodium alginate or similar materials, can be dissolved in deionized (“DI”) water at room temperature to concentrations up to ˜10 wt %. Furthermore, plasticizers such as glycerin, xylitol, or similar materials can be added to the polysaccharide solution if desired. Microcapsules already dispensed in water can be mixed with the polysaccharide solution to form a viscous solution. The viscosity of the resulting slurry (e.g., an aqueous slurry) can be tuned by adjusting the concentration of total solids. The microcapsules can comprise an electrophoretic medium including a first and a second type of electrophoretic particles. The first type of electrophoretic particles can have a different charge and color than the second type of electrophoretic particles. As described above, the electrophoretic particles of the electrophoretic medium can be bistable, and the electrophoretic medium can include a non-polar solvent, polymer stabilizers, and charge control agents.

FIG. 2A and FIG. 2B are diagrams illustrating exemplary methods of fabricating microcapsule threads (e.g., color-changing threads) via triggered cross-linked hydrogels. In FIG. 2A, the polysaccharide/microcapsule phase (and optionally a plasticizer) can be injected via needle 245 into a bath 235 (e.g., a fluid reservoir) of aqueous cross-linker 240, such as 10 wt % calcium chloride, to form a hydrogel matrix that entraps the encapsulated electrophoretic medium within a cross-linked binder, thereby forming microcapsule thread 230. Accordingly, in some embodiments, the hydrogel matrix comprises calcium alginate.

In FIG. 2B, the polysaccharide/microcapsule phase (and optionally a plasticizer) is provided from a first reservoir 250, and the cross-linker solution is provided from a second reservoir 255. Both solutions can be dispensed together using a coaxial needle 260 (e.g., a dispenser). Referring to the enlarged cross section shown in detail view 265, the polysaccharide/microcapsule phase (e.g., aqueous slurry) can be provided from the first reservoir 250 to inlet 270 of the coaxial needle 260, while the cross-linker solution (e.g., aqueous cross-linker) is provided from the second reservoir 255 to inlet 280 of the coaxial needle 260. The polysaccharide/microcapsule phase and cross-linker solution flow separately through chamber 275 and chamber 285, respectively. Both are simultaneously dispensed from outlet 290, at which time the cross-linker solution ionically cross-links or ionically gels the solution rapidly to form a hydrogel matrix that entraps the encapsulated electrophoretic medium within a cross-linked binder, thereby forming microcapsule thread 230. The fabricated microcapsule thread 230 can be washed with DI water prior to drying to remove excess calcium ions.

In some embodiments, chamber 285 concentrically surrounds chamber 275, as in FIG. 2B. In some embodiments, chamber 285 and chamber 275 are positioned side-by-side orthogonal to one another. In each embodiment utilizing a coaxial needle, the polysaccharide/microcapsule phase and cross-linker solution do not come into contact with each other until being dispensed at or near outlet 290. In some embodiments, coaxial needle 260 has a first outlet in fluid communication with inlet 270 and a second outlet in fluid communication with inlet 280. In some embodiments, the first outlet radially surrounds the second outlet. In some embodiments, the first outlet is laterally adjacent to the second outlet. Further, the dispenser can be capable of motion about one or more axes to facilitate fabrication and spooling of the microcapsule threads.

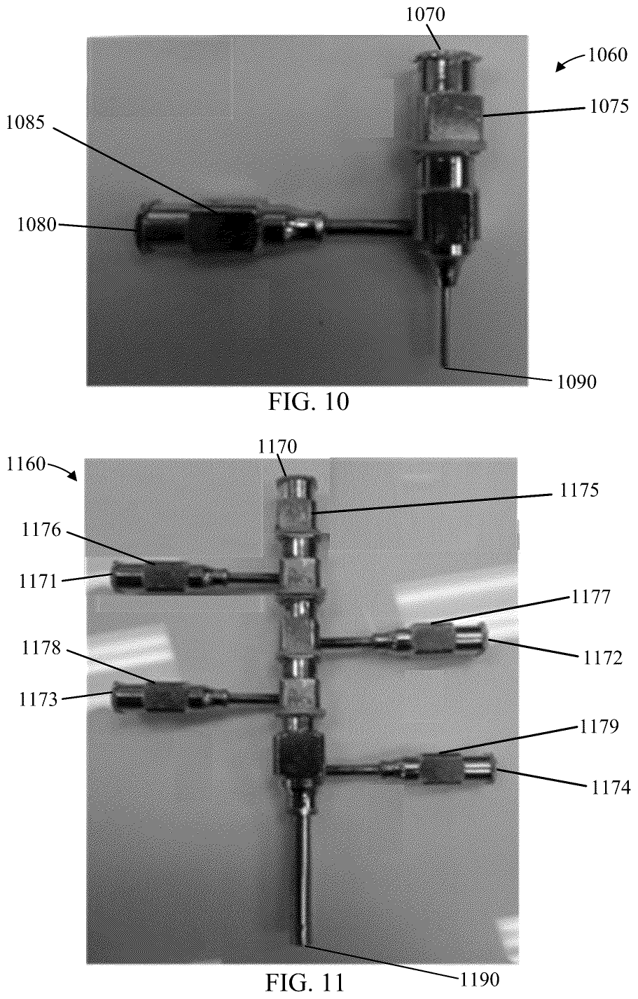

FIG. 10 is an optical image of an exemplary biaxial needle 1060 in accordance with the subject matter disclosed herein. A first reservoir can be in communication with inlet 1070 (e.g., a first inlet) of the biaxial needle 1060 to provide a first material such as a polysaccharide/microcapsule phase, while a second reservoir can be in communication with inlet 1080 (e.g., a second chamber) to provide a second material, such as a cross-linking solution. The polysaccharide/microcapsule phase and cross-linker solution flow separately through chamber 1075 (e.g., a first chamber) and chamber 1085 (e.g., a second chamber), respectively. Both are simultaneously dispensed from outlet 1090, at which time the cross-linker solution ionically cross-links or ionically gels the solution rapidly to form a microcapsule thread as described in detail above. Other embodiments of the subject invention using multi-chambered dispensers are described in detail below with respect to a print head embodiment.

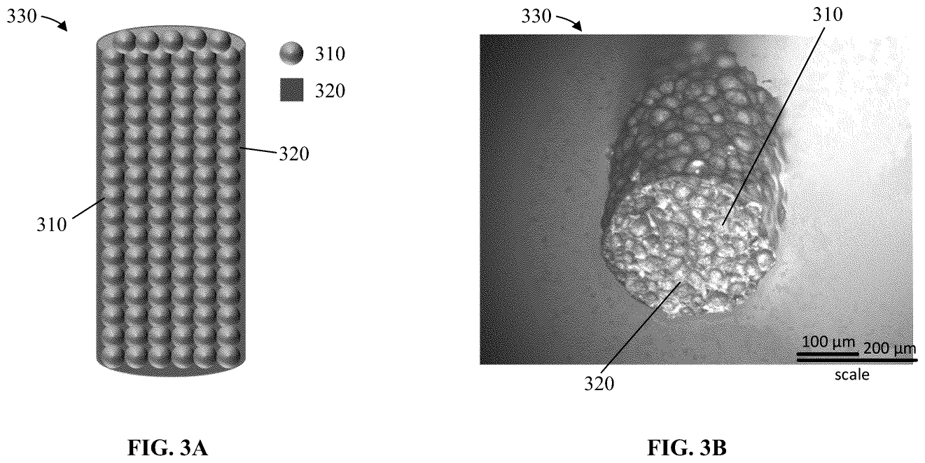

FIG. 3A is schematic diagram showing the exemplary structure of a microcapsule thread 330 having microcapsules 310 trapped within in a hydrogel polymer matrix 320. FIG. 3B shows an optical image of a microcapsule thread 330 having microcapsules 310 trapped within in a hydrogel polymer matrix 320. In the example shown in FIG. 3B, the microcapsule thread 330 has a diameter of approximately 230 μm.

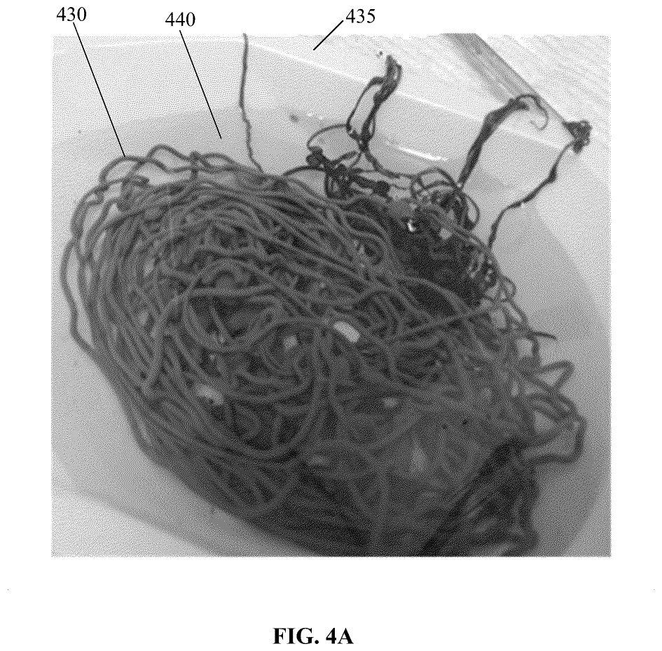

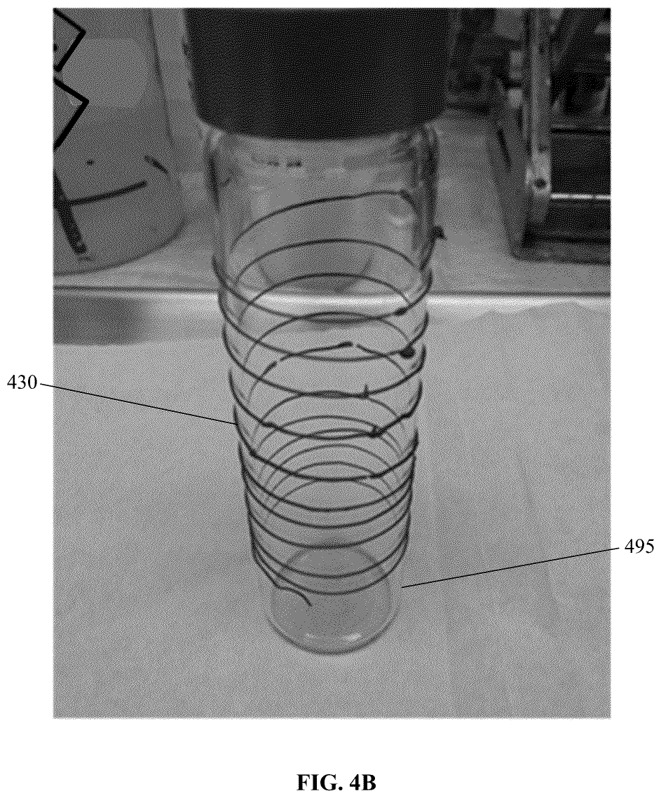

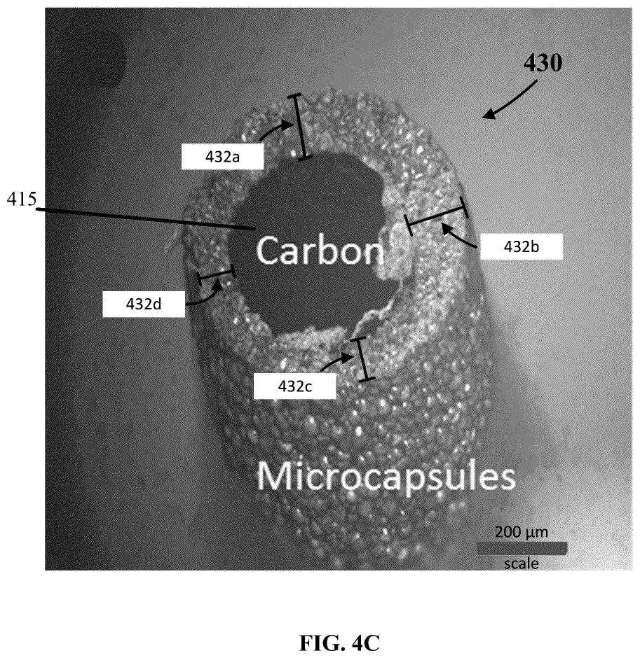

Using the techniques described herein, microcapsule threads of any length and/or width can be fabricated and spooled. FIG. 4A shows an optical image of microcapsule thread 430 fabricated with a predefined thickness and length. Alginate was used as a polysaccharide in the polysaccharide/microcapsule phase which was injected into a bath 435 of aqueous calcium chloride as a cross-linker to form microcapsule thread 430. FIG. 4B shows an optical image of microcapsule thread 430 being spooled around spool 495. The ease with which microcapsule thread 430 can be spooled for later use in commercial applications provides wider commercial utility for microcapsule thread 430 as a raw material.

FIG. 4C shows an optical image of an embodiment of a coaxial microcapsule thread 430 that has been fabricated around a core 415. Core 415 is typically conductive and can be a variety of materials (e.g., conductive carbon, nanoparticles, metal wire, a polymer, etc.). The operating voltage, flexibility, and strength of coaxial microcapsule thread 430 can be adjusted by changing the ratio of ingredients and core materials. It is a standard aqueous process which can be run using existing in-house materials and setup.

In some embodiments, a conductive core (e.g., core 415) is provided, and at least a portion of the conductive core is coated with a hydrogel matrix such as the hydrogel matrix described above in connection with FIG. 2A. In some embodiments, a dipping process is used to coat the conductive core with the hydrogel matrix, and the conductive core is drawn from the hydrogel matrix at a predetermined rate to form a hydrogel-matrix-coated conductive core. In some embodiments, the hydrogel-matrix-coated conductive core is then dipped in a conductive polymer (e.g., PEDOT, polyacetylene, polyphenylene sulfide, and polyphenylene vinylene), and the hydrogel-matrix-coated conductive core is drawn from the conductive polymer at a second predetermined rate, thereby coating the hydrogel-matrix-coated conductive core with a conductive layer that can serve as a conductive electrode layer.

FIG. 4C shows four measurements of the thickness (432a-432d) of the microcapsules trapped within in the hydrogel polymer matrix surrounding the core 415: thickness 432a=112.33 μm, thickness 432b=130.15 μm, thickness 432c=76.29 μm, and thickness 432d=76.70 μm.

As discussed above, the inventive subject matter disclosed herein includes improved dispensers and processes for fabricating color-changing, electrically-switchable electrophoretic fibers/threads via rapid gelation. In addition to the two-chambered coaxial needle 260 described above, the invention also features a self-contained pen dispenser or print head comprising a pentaxial (5 outlet) nozzle, where each nozzle outlet is connected to an individual reservoir or chamber for receiving one of the materials required for the rapid gelation fabrication process. As the materials exit their dedicated reservoirs through one of the five concentric nozzle outlets, cross-linking reactions are used to fabricate concentric layers of thin films. Thus, the dispenser is able to smoothly combine multiple cross-linked layers into a single structure consisting of layered films to produce electrically-switchable electrophoretic threads. The dispenser can be incorporated into a plotter to make designs of any kind and dimension on different substrates.

The dispenser is a self-contained instrument for writing and drawing with color-changing, electrically-switchable electrophoretic threads. For small applications, such as arts and crafts, thin threads can be drawn via a pen, while for larger display applications, a print head can be used to dispense thick threads. The dimensions of the thread can be changed to suit the application, ranging in size from doodles or scrap booking projects, to architectural displays. The dispenser is capable of instantly dispensing a complete set of switchable, electrophoretic threads on any surface. The dispenser can also be used to make conducting as well as insulating lines for electrical connections or sealing applications.

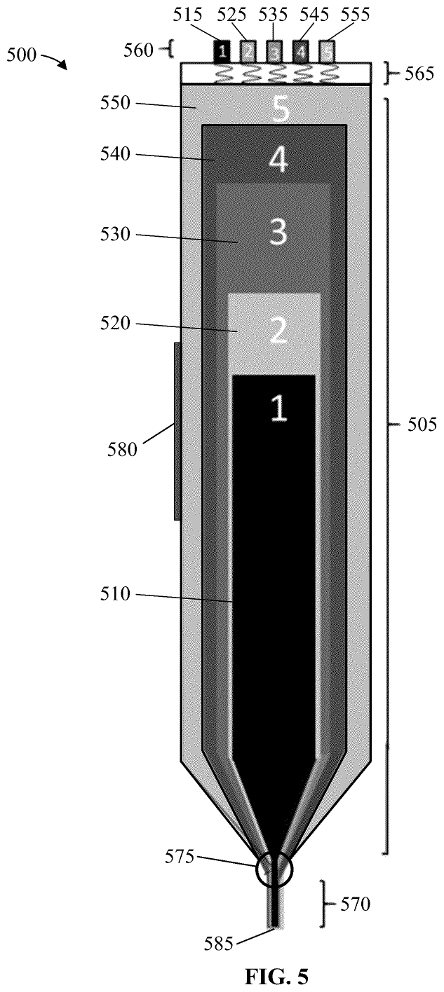

FIG. 5 shows a cross-sectional diagram of an exemplary microcapsule thread dispenser 500 in accordance with the subject matter disclosed herein. In some embodiments, the dispenser 500 is constructed in the form of a pen that can be held in the operator's hand. The dispenser 500 includes a body 505 housing several concentric cylinders that serve as reservoirs for the materials used to fabricate color-changing electrophoretic threads.

Moving from the inner most to the outermost cylindrical reservoir, body 505 includes reservoir 510 (e.g., a first reservoir), reservoir 520 (e.g., a second reservoir), reservoir 530 (e.g., a third reservoir), reservoir 540 (e.g., a fourth reservoir), and reservoir 550 (e.g., a fifth reservoir). Table 1 provides a list of exemplary materials that can be stored in each cylindrical reservoir. One of skill in the art will appreciate that the list of materials in Table 1 and their locations within body 505 are exemplary and not exhaustive. The materials are not limited to being stored in only the reservoir listed in Table 1, and other materials not listed in Table 1 can be stored in the reservoirs depending on the parameters of the color-changing electrophoretic threads being fabricated.

TABLE 1

| | Reservoir in |
|---|---|
| Material(s) | Dispenser 500 |
| Conductive Carbon + Polysaccharide | 510 |
| Capsules + Polysaccharide | 520 |
| Transparent Conductor + Polysaccharide | 530 |
| Protective Particle/Polymer + Polysaccharide | 540 |
| Cross-linking Agent | 550 |

Returning to FIG. 5, the reservoirs are tapered near the bottom of body 505 and eventually merge to form a pentaxial needle within the nib 570 near the outlet 585 of the dispenser 500. A series of flow valves have been introduced at the beginning of the nib 570 to regulate the flow of materials and prevent back flow. These valves are located within detail 575, a detail view of which is shown in FIG. 6. Referring to FIG. 6, flow valve 616 (e.g., a first flow valve) regulates the flow of materials from reservoir 510, flow valve 626 (e.g., a second flow valve) regulates the flow of materials from reservoir 520, flow valve 636 (e.g., a third flow valve) regulates the flow of materials from reservoir 530, flow valve 646 (e.g., a fourth flow valve) regulates the flow of materials from reservoir 540, and flow valve 656 (e.g., a fifth flow valve) regulate the flow of materials from reservoir 550.

Returning to FIG. 5, the uppermost part of the dispenser 500 has an array of switches for individually controlling the operation of the flow valves to effectively select the materials to be dispensed. In particular, switch 515 (e.g., a first switch) controls the flow valve 616 for reservoir 510, switch 525 (e.g., a second switch) controls the flow valve 626 for reservoir 520, switch 535 (e.g., a third switch) controls the flow valve 636 for reservoir 530, switch 545 (e.g., a fourth switch) controls the flow valve 646 for reservoir 540, and switch 555 (e.g., a fifth switch) controls the flow valve 656 for reservoir 550. For example, depressing switch 515 causes flow valve 616 to open to allow material from reservoir 510 to flow into the pentaxial needle within the nib 570.

Battery-operated pressure pump 565 controls the flow rate of all the materials required for specific applications. In some embodiments, the flow rates of all of the materials are optimized and locked such that the user does not have the ability to change them. In some embodiments, the flow rates can be selected by the user. For example, the switches that control the flow valves can be multi-position switches, and the pump 565 can be configured to adjust the flow rate depending on the position of a particular switch.

The flow valves can also be controlled by a shutoff switch 580 which prevents clogging and drying by closing all of the valves to stop delivery of all materials. In the event any of the flow paths within the nib 570 become clogged due to gelation, the nib 570 can be cleaned by sonicating in sodium citrate, followed by a DI water wash. Although not shown in FIG. 5, body 505 can also include a compartment for holding one or more batteries along with any supporting electronics and wires needed to control operation of the dispenser 500.

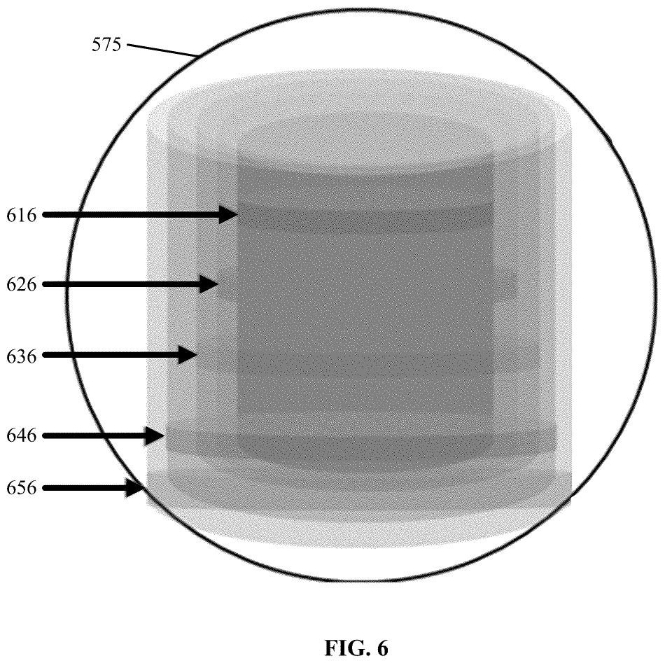

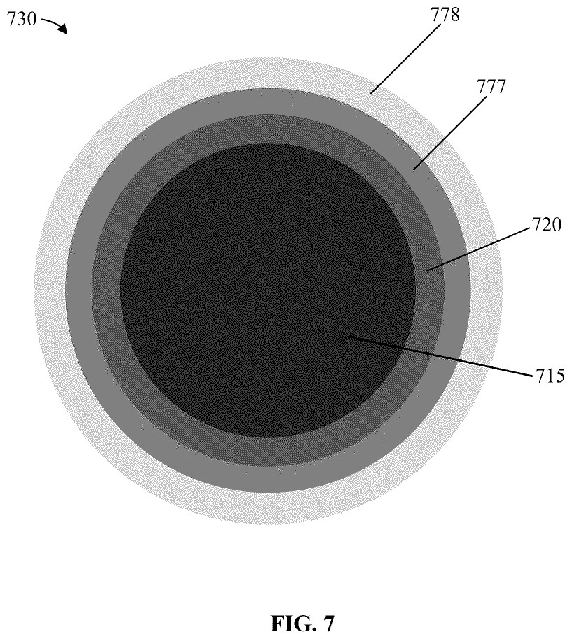

FIG. 7 shows a cross-sectional diagram of an exemplary color-changing electrophoretic thread 730 formed by the dispenser 500. Thread 730 has a conductive inner core 715, surrounded by, in order, concentric layers of microcapsules 720, a transparent conductor 777, and a protective coating 778. All layers are cross-linked using the pentaxial needle within the nib 570 to form a free standing thread with electrophoretic switching capability upon exit from outlet 585 of the dispenser 500.

Advantageously, the materials used in the dispenser 500 to fabricate color changing electrophoretic threads 730 are off-the-shelf materials, or materials that are straightforward to make by modifying existing electrophoretic inks and related materials.

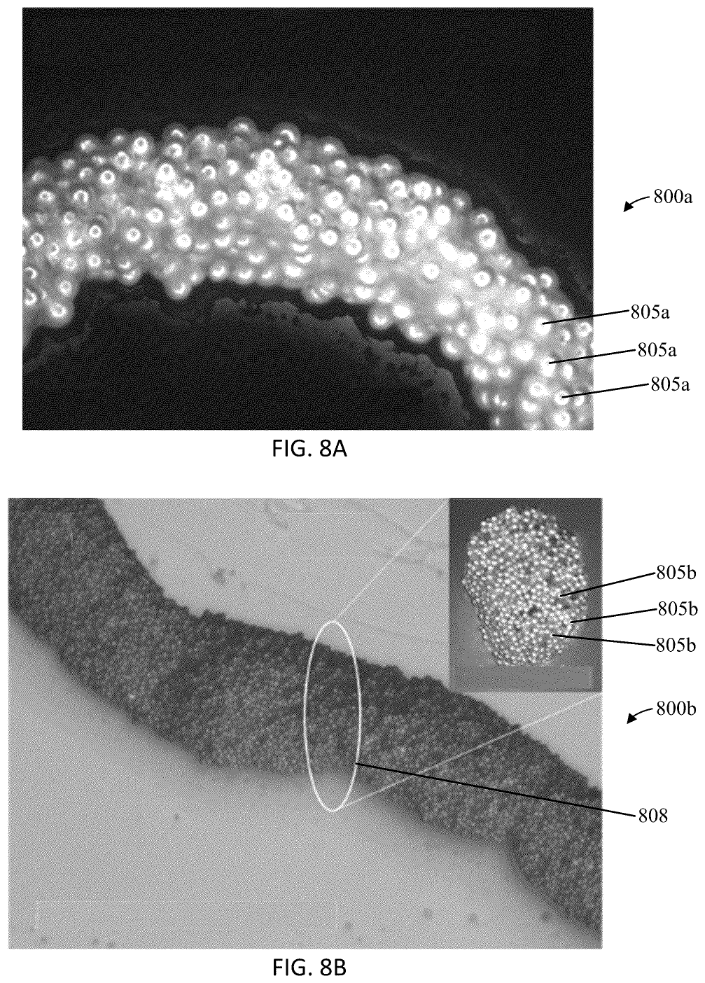

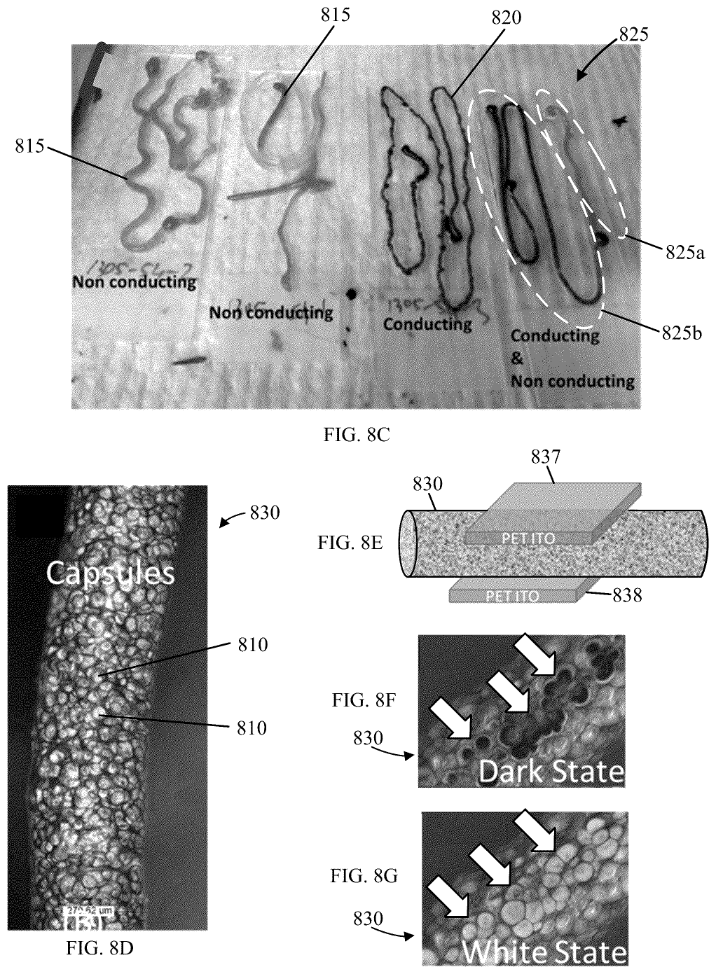

The inner core 715 can serve as the back/rear electrode of thread 730 and includes conducting particles imbedded in a polymer matrix. This arrangement provides the inner core 715 with both electrical conductivity and mechanical flexibility. Different kinds of conductive particles, such as carbon, metal, or metal-coated polymer beads, can be used with rapidly cross-linking polymers, such as polysaccharides, to form the inner core 715. FIG. 8A shows an optical image 800a of an exemplary conductive thread made from silver coated PMMA beads 805a (three examples of PMMA beads 805a are identified in FIG. 8A) in an alginate hydrogel. FIG. 8B shows an optical image 800b of an exemplary conductive thread made from gold particles 805b (three examples of gold particles 805b are identified in FIG. 8B) via cross-linking of sodium alginate with calcium chloride. Detail view 808 of FIG. 8B shows the dense packing and uniform distribution of the gold particles 805b within a cross section of the thread 800b. FIG. 8C shows an optical image of non-conductive threads 811 and conductive carbon threads 813 drawn onto glass slides. Non-conductive threads 811 have been dyed a pink color using rhodamine dye, while the conductive carbon threads 813 appear black due to the presence of conductive carbon black particles. The conductive threads can be used for making electrical connections, while the non-conductive threads can be used for isolating electrical components.

A thread can also be fabricated to include conducting as well as non-conducting parts formed into a single thread. For example, FIG. 8C shows combination thread 824 formed to have a non-conductive portion 824a and a conductive portion 824b. The lighter, non-conductive portion 824a has been dyed a pink color using rhodamine dye, while the darker conductive portion 824b appears black due to the presence of conductive carbon black particles.

Referring back to FIG. 7, the conductive inner core 715 is surrounded by a layer of microcapsules 720 in a polymer matrix. Microcapsules can be entrapped in the same polymer that is used to form inner core 715 so that the microcapsules can be cross-linked together. For example, FIG. 3B, described above, shows an optical image of a microcapsule thread 330 having microcapsules 310 trapped within in a hydrogel polymer matrix 320. Further, FIG. 4C, described above, shows an embodiment of a coaxial microcapsule thread 430 that has been fabricated around a core 415 utilizing a coaxial needle. FIG. 8D shows an optical image of a microcapsule thread 830 having microcapsules 810 trapped within in a hydrogel polymer matrix. As demonstrated by FIG. 8D, threads fabricated using this method have a consistent and uniform structure throughout the length of the thread.

FIG. 8E is a schematic diagram showing an exemplary test setup used to test the electrophoretic activity of a microcapsule thread 830. As shown, microcapsule thread 830 was sandwiched between two PET-ITO substrates 837 and 838, and different voltage potentials were applied to the PET-ITO substrates to cause the charged pigment particles to move within the microcapsules.

FIG. 8F shows an optical image of a microcapsule thread 830 that has been driven to a black or dark state. In FIG. 8F, a voltage potential has been applied across microcapsule thread 830 such that the black pigment particles (identified by the white arrows) have moved to the top (e.g., viewable) surface of the microcapsules, and the white pigment particles have moved away from the top surface of the microcapsules. FIG. 8G shows an optical image of a microcapsule thread 830 that has been driven to a light or white state. In FIG. 8G, a voltage potential has been applied across microcapsule thread 830 such that the white pigment particles (identified by the white arrows) have moved to top the surface of the microcapsules, and the black pigment particles have moved away from the top surface of the microcapsules.

The dark and white states shown in FIG. 8F and FIG. 8G were approximately 25 and 50 L*, respectively. These L* measurements were made for proof of concept only, and are not expected to be fully accurate due to the relative difficulty in measuring the switching portion, which is a small contact area between the cylindrical thread and the planar PET-ITO substrate films.

Referring back to FIG. 7, the layer of transparent conductor 777 can be fabricated using transparent conducting particles imbedded in a polymer matrix, which can provide a layer having transparency, conductivity, and flexibility. Materials with good transparency and conductivity can be used to form the transparent conductor 777 layer around the layer of microcapsules 720. In some embodiments, materials such as PEDOT, CNT, graphene, or related materials are used to form transparent conductor 777.

The protective coating 778 is the outermost layer and can be used for mechanical and environmental protection. The layer of protective coating 778 can be formed using polysaccharides with additives, such as clay, or polymer particles that can be instantaneously and simultaneously cross-linked. In some embodiments, polysaccharides with additives, such as clay, or polymer particles are instantaneously and simultaneously cross-linked with one or all of the layers to form multiple protective layers.

The operation of the dispenser 500 shown in FIG. 5 will now be described in the context of forming several different varieties of threads discussed herein. As described above, depressing or activating one of the switches at the top of the dispenser 500 causes the flow of materials from its respective reservoir to the pentaxial needle within the nib 570 and subsequently out of the outlet 585. When multiple switches are depressed or activated at the same time, the materials from their respective reservoirs can be reacted upon contact to form a new material having vastly different properties than its constituent parts. Accordingly, certain combinations of switches can be selected depending on the desired output from dispenser 500. Table 2 lists some exemplary combinations of switches needed to dispense particular desired outputs.

TABLE 2

| Desired Output | Switch Selections |
|---|---|
| Electrophoretic display | 515 + 525 + 535 + 545 + 555 |
| Black conductive thread | 515 + 555 |
| Transparent conductive thread | 535 + 555 |
| Insulating thread or sealing | 545 + 555 |

For a complete electrophoretic switching display, switches 515, 525, 535, and 545, which deliver the materials needed to form the conductive inner core 715, and the layers of microcapsules 720, transparent conductor 777, and protective coating 778, must be selected or activated. Switch 555 must be selected or activated for every process since every process uses a cross-linking agent. In some embodiments, as a convenience to the user, the reservoir 550 holds the largest volume of material so that the cross-linking agent does not have to be frequently refilled.

In order to dispense conductive threads which can be used, for example, for onboard electrical connections on printed circuit boards or other substrates, either of switches 515 and switch 535 can be activated along with switch 555. For example, if a black conductive thread is the desired output, swith 515 can be activated (along with switch 555) such that the conductive element is formed from conductive carbon and polysaccharide, as with the exemplary conductive carbon thread 820 shown in FIG. 8C. If a transparent conductive thread is the desired output, swith 535 can be activated (along with switch 555) such that the conductive element is instead formed from a transparent conductor and polysaccharide.

For dispensing a thread made for sealing or insulating applications, switch 545 and 555 can be selected to dispense a thread formed from the protective particle/polymer and polysaccharide from reservoir 540. If alternating conducting and insulating thread is required, switch 515 and switch 545 can can be alternately depressed along with 555.

Materials dispensed from the selected reservoir instantly form a hydrogel by reacting with the cross-linking agent (e.g., CaCl₂) flowing from reservoir 550. The thread formed after cross-linking is initially wet and shrinks as it dries. Drying can take 30-40 minutes and may vary depending on ambient temperature and humidity. Use of a single polymer matrix provides strong cohesive force between the layers and prevents delamination during the drying process. Drying typically reduces the diameter of the thread by an order of magnitude. Electrical connections to the different conductors within the thread can be made once drying is complete, as described in detail further below.

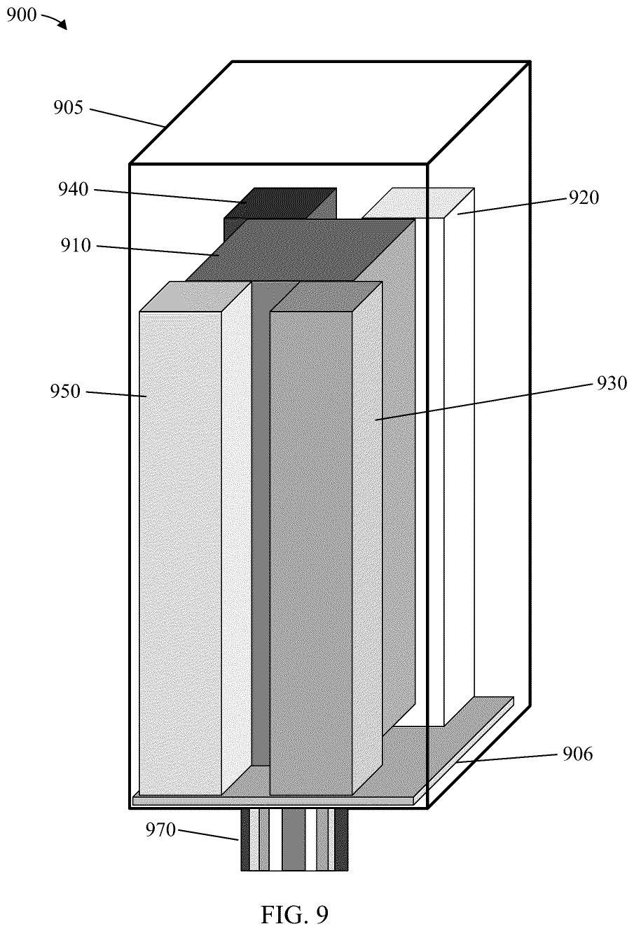

FIG. 9 shows a schematic diagram of a print head 900 including a multi-reservoir assembly for storing materials used in the synthesis of color-changing electrophoretic threads. The print head 900 is used for dispensing thicker and more robust color-changing electrophoretic threads for use in larger scale applications such as architectural and signage applications. In some embodiments, the print head 900 is part of a printer or plotter.

The print head 900 includes a body 905 housing an array of chambers or reservoirs (reservoir 910 or a first reservoir, reservoir 920 or a second reservoir, reservoir 930 or a third reservoir, reservoir 940 or a fourth reservoir, and reservoir 950 or a fifth reservoir) for holding the various materials that are dispensed to fabricate color-changing electrophoretic threads. Table 3 provides a list of exemplary materials that can be stored in each reservoir.

TABLE 3

| | Reservoir in |
|---|---|
| Material(s) | Print Head 900 |
| Conductive Carbon + Polysaccharide | 910 |
| Capsules + Polysaccharide | 920 |
| Transparent Conductor + Polysaccharide | 930 |
| Protective Particle/Polymer + Polysaccharide | 940 |
| Cross-linking Agent | 950 |

Each reservoir sits on a control unit 906 and opens up to a pentaxial nozzle 970 through the control unit 906 which operates a series of valves used to regulate the flow of each material according to the dispensing requirements.

As mentioned above, the print head 900 produces thicker and more robust threads than the dispenser 500. For fabricating the thicker threads, the dispensing nozzle 970 is similar to the nib 570 of the dispenser 500, but is configured to produce a larger internal central core diameter than the conductive inner core 715 produced by the dispenser 500. In order to retain optimum electro-optic performance by the finished thread, the layer thickness of the microcapsules and conductors can be the same or similar to the thickness of the microcapsules 720 and the transparent conductor 777 fabricated using dispenser 500. Similar to a conventional ink printing head, the dispenser or print head 900 can be capable of motion about one or more axes to facilitate fabrication and spooling of the microcapsule threads.

FIG. 11 is an optical image of an exemplary pentaxial needle 1160 in accordance with the subject matter disclosed herein. Each of the reservoirs 910, 920, 930, 940, and 950 can be in communication with one of the inlets 1170 (e.g., a first inlet), 1171 (e.g., a second inlet), 1172 (e.g., a third inlet), 1173 (e.g., a fourth inlet), and 1174 (e.g., a fifth inlet) of the pentaxial needle 1160 for providing the materials needed to fabricate color-changing electrophoretic threads. When selected for a particular process, each material flows separately through chambers 1075 (e.g., a first chamber), 1076 (e.g., a second chamber), 1077 (e.g., a third chamber), 1078 (e.g., a fourth chamber), and 1079 (e.g., a fifth chamber), respectively, under control of the control unit 906. The selected materials are simultaneously dispensed from outlet 1190, at which time the cross-linker solution (which is typically selected for every operation) ionically cross-links or ionically gels the other solution(s) rapidly to form a new material having different properties than its constituent parts.

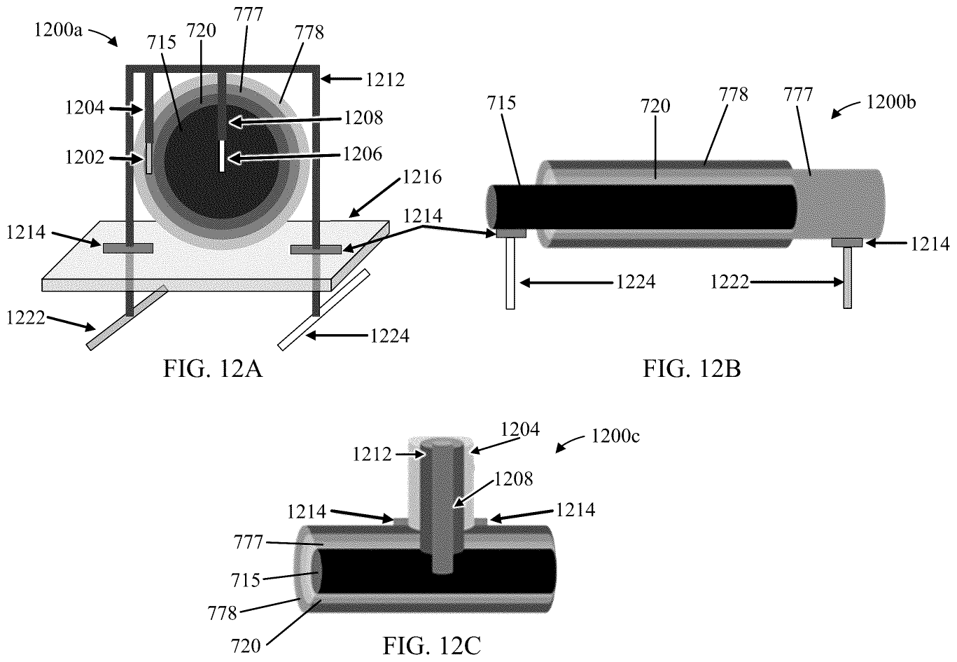

FIGS. 12A-12C show schematic diagrams of exemplary components for making connections to finished color-changing electrophoretic threads.

FIG. 12A shows a schematic diagram 1200a of a pin and connector configuration termed the “pi connector” for making connections to a color-changing electrophoretic thread such as thread 730 described in connection with FIG. 7. The pi connector includes connector leg 1204 (e.g., a first connector leg) and connector leg 1208 (e.g., a second connector leg) which are covered in electrical insulator 1212 everywhere except for the places where they make electrical connection using pin 1202 (e.g., a first pin) and pin 1206 (e.g., a second pin), respectively. For example, a connection to the transparent conductor 777 is made by piercing a side of thread 730 with the pin 1202 in connector leg 1204, while a connection to the conductive inner core 715 is made by piercing into the center of thread 730 with the pin 1206 in connector leg 1208. Stoppers 1214 control the extent to which pin 1202 and pin 1206 pierce into thread 730 and provide stability for the pins once the pi connector is attached to a substrate 1216.

Connections from the conductors of thread 730 can be made to voltage sources that can apply different voltage potentials to cause the charged pigment particles within the microcapsules to move. For example, the connection made to the transparent conductor 777 by pin 1202 in the connector leg 1204 can be routed through the substrate 1216 to voltage source supply line 1222. Further, the connection made to the conductive inner core 715 by pin 1206 in the connector leg 1208 can be routed through the substrate 1216 to voltage source supply line 1224. Application of different voltage potentials to voltage source supply line 1222 and voltage source supply line 1224 causes the charged pigment particles within the microcapsules to move.

In some embodiments, the transparent conductor 777 and the conductive inner core 715 can be made to contact points or pads on the top or bottom sides of substrate 1216, and the contact points are in electrical communication with the voltage source supply line 1222 and the voltage source supply line 1224. In some embodiments, the substrate 1216 is a form of paper designed with built-in connection features similar to the raised features of braille. The pi connector advantageously allows electrical connections to be made to thread 730 anywhere along the length of thread 730.

FIG. 12B shows a schematic diagram 1200b of a linear connector configuration for making connections to a color-changing electrophoretic thread such as thread 730 described in connection with FIG. 7. In this configuration, portions of the conductive inner core 715 and the transparent conductor 777 are left exposed to serve as connection points.

A conductive pin (not shown) having an electrical connection to the voltage source supply line 1222 can be inserted into the transparent conductor 777. Likewise, a conductive pin (not shown) having an electrical connection to the voltage source supply line 1224 can be inserted into the conductive inner core 715. Stoppers 1214 set the piercing depth of the conductive pins. The exposed sites for connection to the conductive inner core 715 can be formed by dispensing only the materials need to form the conductive inner core 715 (e.g., conductive carbon and polysaccharide solution, and the cross-linking agent) while ceasing to dispense all other materials. Similarly, exposed sites for connection to the transparent conductor 777 can be formed by dispensing only the materials need to form the transparent conductor 777 (e.g., transparent conductor and polysaccharide solution, and the cross-linking agent) while ceasing to dispense all other materials.

FIG. 12C shows a schematic diagram 1200c of a coaxial connector configuration for making connections to a color-changing electrophoretic thread such as thread 730 described in connection with FIG. 7. In this configuration, electrical connections to the transparent conductor 777 and the conductive inner core 715 can be made by a single coaxial wire with a dielectric or insulator layer 1212 separating the conductive layers of the coaxial wire to prevent short circuit failures.

A conductive pin (not shown) in connector leg 1204 having an electrical connection to the voltage source supply line 1222 can be inserted into the transparent conductor 777. Likewise, a conductive pin (not shown) in connector leg 1208 having an electrical connection to the voltage source supply line 1224 can be inserted into the conductive inner core 715. Stoppers 1214 set the piercing depth of the conductive pins. The coaxial connector advantageously allows electrical connections to be made to thread 730 anywhere along the length of thread 730, as it is not necessary to expose areas of the underlying layers of thread 730 for making connections.

The ideal distance between the connectors can be determined based on the conductivity of the conductive layers of the thread. In the case where connectors are applied at the start and end of the thread, the length of the thread would be determined by the conductivity, and hence can be changed by the carbon solid ratio or via addition of nanostructures (e.g., CNT).

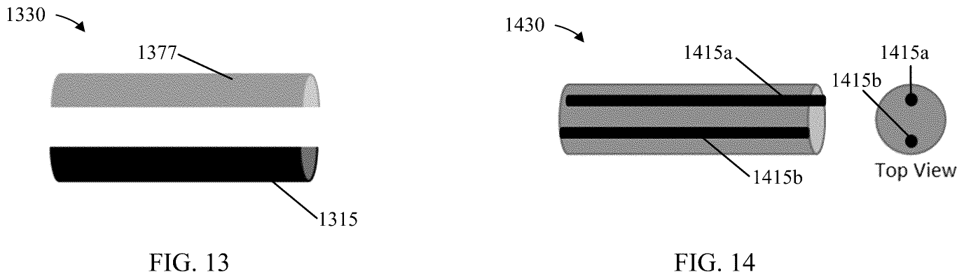

For some applications, transparency and conductivity of the transparent conductor may be difficult to achieve due to high aspect ratio. As shown in FIG. 13, a modified thread 1330 can incorporate a transparent conductor 1377 on its top side and a highly conductive line 1315 on its bottom side to enhance electrical conductivity, allowing for longer lengths of thread 1330 between connection points to a voltage source. In some embodiments, the highly conductive line 1315 is formed from the same material used to form the conductive inner core 715. Reconfiguration of the dispensing needle is required for this modification. Another possibility is to add small diameter wires 1415a (e.g., a first wire) and 1415b (e.g., a second wire) within the outer transparent conductor 1477 as it is extruded, as shown in thread 1430 of FIG. 14.

Accordingly, the invention described herein provides flexible threads or fibers that can be switched between colors on demand that are more mechanically robust. The invention also provides a method of fabricating spoolable microcapsule threads having a controlled length and thickness. The methods used for fabrication are safe and environmentally green. Directly dispensing functional electrophoretic threads reduces material waste as the active display elements are printed at selected places, as needed. These methods also increases flexibility in the types and varieties of displays that can be produced. The inventive dispenser provides a miniaturized electrophoretic display fabrication system that can be formed as a dispensing pen and used for a variety of purposes.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

The contents of all of the aforementioned patents and applications are incorporated by reference herein in their entireties

1. A method for fabricating a color-changing thread, the method comprising:
providing an aqueous slurry comprising an encapsulated electrophoretic medium and a binder, wherein the electrophoretic medium includes a first and a second type of electrophoretic particles, the first type of electrophoretic particles having a different charge and color than the second type of electrophoretic particles;
injecting the aqueous slurry into a fluid reservoir holding an aqueous cross-linker; and
forming a hydrogel matrix that entraps the encapsulated electrophoretic medium within a cross-linked binder.

2. The method of claim 1 wherein the aqueous binder comprises a polysaccharide.

3. The method of claim 1 wherein the aqueous binder comprises sodium alginate.

4. The method of claim 1 wherein the aqueous cross-linker comprises calcium chloride.

5. The method of claim 1 wherein the aqueous binder further comprises a plasticizer.

6. The method of claim 5 wherein the plasticizer comprises one of glycerin and xylitol.

7. The method of claim 1 wherein the hydrogel matrix comprises calcium alginate.

8. The method of claim 1 wherein the electrophoretic medium is bistable.

9. The method of claim 1 wherein the electrophoretic medium comprises a non-polar solvent, polymer stabilizers, and charge control agents.

10. The method of claim 1 further comprising providing a conductive core, and coating at least a portion of the conductive core with the hydrogel matrix.

11. The method of claim 10 wherein coating comprises:
dipping the conductive core in the hydrogel matrix; and
drawing the conductive core from the hydrogel matrix at a predetermined rate, thereby forming a hydrogel-matrix-coated conductive core.

12. The method of claim 10 wherein the conductive core material comprises one of conductive carbon, nanoparticles, metal wire, and a polymer.

13. The method of claim 11 further comprising:
dipping the hydrogel-matrix-coated conductive core in a conductive polymer; and
drawing the hydrogel-matrix-coated conductive core from the conductive polymer at a second predetermined rate, thereby coating the hydrogel-matrix-coated conductive core with a conductive electrode layer.

14. The method of claim 13 wherein the conductive polymer material comprises one of PEDOT, polyacetylene, polyphenylene sulfide, and polyphenylene vinylene.

15. A method for fabricating a color-changing thread, the method comprising:
providing an aqueous slurry comprising an encapsulated electrophoretic medium and a binder, wherein the electrophoretic medium includes a first and a second type of electrophoretic particles, the first type of electrophoretic particles having a different charge and color than the second type of electrophoretic particles;
dispensing the aqueous slurry from a first outlet of a dispenser; and
dispensing an aqueous cross-linker from a second outlet of the dispenser proximate to the first outlet,
thereby forming a hydrogel matrix that entraps the encapsulated electrophoretic medium within a cross-linked binder.

16. The method of claim 15 wherein the aqueous binder comprises a polysaccharide.

17. The method of claim 15 wherein the aqueous binder comprises sodium alginate.

18. The method of claim 15 wherein the aqueous cross-linker comprises calcium chloride.

19. The method of claim 15 wherein the aqueous binder further comprises a plasticizer.

20. The method of claim 19 wherein the plasticizer comprises one of glycerin and xylitol.

21. The method of claim 15 wherein the hydrogel matrix comprises calcium alginate.

22. The method of claim 15 wherein the first outlet is laterally adjacent to the second outlet.

23. The method of claim 15 wherein the dispenser comprises a coaxial needle.

24. The method of claim 15 wherein the first outlet radially surrounds the second outlet.

25. The method of claim 15 wherein the dispenser is capable of motion about one or more axes.
